(19) United States
(12) Patent Application Publication
(10) Pub. No.: US 2019/0168235 A1
(43) Pub. Date: Jun. 6, 2019

(54) RECOVERING METALS AND AGGREGATE USING MULTIPLE SCREW SEPARATORS

(71) Applicant: Thomas A VALERIO, Atlanta, GA (US)

(72) Inventor: Thomas A VALERIO, Atlanta, GA (US)

(21) Appl. No.: 16/324,869

(22) PCT Filed: Aug. 9, 2017
(86) PCT No.: PCT/US2017/046174

§ 371 Date: Feb. 11, 2019

Related U.S. Application Data
(60) Provisional application No. 62/372,792, filed on Aug. 9, 2016.

(51) Int. Cl. B03B 9/06; B03C 1/10; B03C 1/30; B03B 9/04; B02C 23/20; B03B 5/56

(52) U.S. Cl. CPC B03B 9/061; B03C 1/10; B03C 1/30; B03B 2009/068; B02C 23/20; B03B 5/56; B03B 9/04

(57) ABSTRACT

A system and method for recovering metals from a waste stream includes or uses a feeder, a first screw separator, a slurry tank, and a second screw separator configured to receive carrier fluid and particles from the slurry tank. The method and system can include feature to improve water usage.

### PRIOR RELATED APPLICATION DATA

This application claims the benefit of priority to U.S. Provisional Patent Application Ser. No. 62/372,792, filed Aug. 9, 2016, which is incorporated by reference.

### TECHNICAL FIELD

This disclosure generally relates to metal recovery, and more particularly relates to recovering metals from a waste stream containing metals (e.g., incinerator ash, automobile shredder residue and electronic shredder residue).

### BACKGROUND

Around the world, attention is paid to the adverse environmental effects of landfilling waste. Proper landfilling of waste requires large areas of land, which may be in limited supply in certain urban areas. The waste also may pose adverse environmental effects, including effects to water tables underlying disposal sites, due to contamination from chemicals and heavy metals contained in the waste.

Recovery of these valuable resources has been instituted in various waste streams. For example, at the end of its useful life, an automobile is shredded. This shredded material includes ferrous and non-ferrous metals. The remaining materials that are not recovered are referred to as automobile shredder residue (“ASR”), which may also include ferrous and non-ferrous metals, including copper wire and other recyclable materials. Presently, ASR is typically disposed of in a landfill. Similar efforts have been made to recover materials from whitegood shredder residue (“WSR”), which includes the waste materials left over after recovering ferrous metals from shredded machinery or large appliances. Moreover, efforts have been made to recover materials from electronic components (also known as “e-waste” or “waste electrical and electronic equipment” (“WEEE”)), building components, retrieved landfill material, and other industrial waste streams. These waste streams may be “virgin,” i.e., the residue after the removal of ferrous metals, or “non-virgin,” i.e., the waste resulting from subsequent processing to recover certain metals and plastics.

There is always a need for improved systems and methods to recover materials from waste streams.

### SUMMARY

One aspect includes a system for recovering metals from a waste stream comprising a feeder that is configured to introduce the waste stream into the system. The flow rate of the waste stream is adjustable. The aspect also includes a first screw separator configured to receive the waste stream from the feeder. The first screw separator further comprises a first walled bed that receives settled particles from the waste stream. Also included is a slurry tank configured to receive the particles that settle within the first walled bed. The aspect further includes a carrier fluid configured to disperse the particles uniformly within the slurry tank, and the carrier fluid is introduced into the slurry tank. The aspect also includes a second screw separator configured to receive carrier fluid and particles from the slurry tank. In this aspect, the carrier fluid flows at a constant velocity. Additionally included is a plurality of walled beds configured to receive particles from the waste stream that settle as the waste stream passes along the screw separators. Each of the walled beds has an adjustable pitch. A weir with an adjustable height is further included. Finally, this aspect also provides a controlled liquid flow configured to dispense water to the first screw separator and the second screw separator.

A second aspect includes a method for processing mixed solid waste to recover metals from a waste stream comprising passing a waste stream through the system as described in the aspect above and separating particles within the waste stream according to the particles' settling velocities and densities.

These and other features of the embodiments disclosed herein will become more fully apparent from the following description and appended claims.

### BRIEF DESCRIPTION OF THE DRAWINGS

This disclosure is illustrated in the figures of the accompanying drawings which are meant to be illustrative and not limiting, in which like references are intended to refer to like or corresponding parts, and in which:

FIG. 1 illustrates an exemplary equipment layout diagram for a waste stream containing metal processing system in accordance with the present disclosure; and

FIG. 2 illustrates a system for recovering metals from a waste stream according to the present disclosure.

### DETAILED DESCRIPTION

The waste stream may include waste streams having characteristics similar to incinerator ash, ASR, WSR, and WEEE. ASR, WSR, and WEEE, and incinerator ash have metals that include hair wires or electronic pin connectors or metals with flat, flake-like shapes. A “mixed waste stream containing metals” includes, but is not limited to, these waste streams.

This disclosure relates to systems and methods for recovering metal constituents from a waste stream containing metals. In specific embodiments, the methods and systems include multiple screw separators. These separators may use a carrier liquid such as water/rinse water, for example, to separate particles according to the particles' settling velocities and densities. In other embodiments, the carrier liquid may be mud or a magnetite mixture. A magnetic separator may also be employed, which removes ferrous particles from a portion of the waste stream.

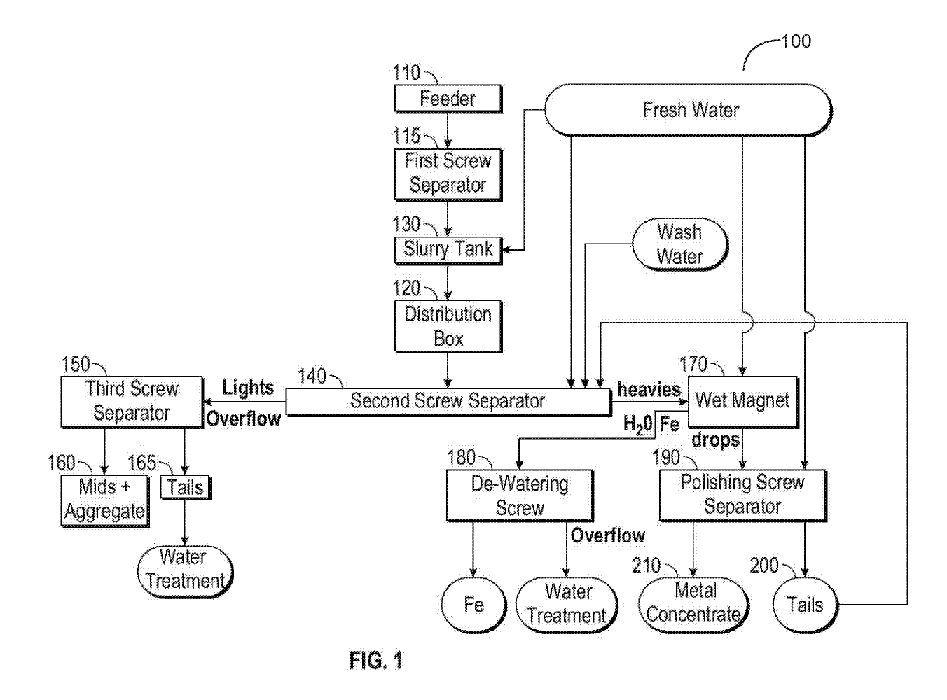

Referring to FIG. 1, an equipment layout or flow diagram 100 for a system that processes mixed waste streams containing metals is described. The equipment layout 100 represents an exemplary layout and method. Therefore, various aspects may be omitted depending on implementation and design choice.

As can be seen, specific embodiments include the use of multiple screw separators having a screw auger positioned over a walled bed, with the entire device positioned on an adjustable incline angle of between 10 and 28 degrees with respect to the horizontal plane or between 8 and 15 degrees with respect to the horizontal plane or between 14 and 25 degrees with respect to the horizontal plane. At the lower end of the incline is a weir with an adjustable height. A slurry of material can be introduced to a screw separator at the positions of different “flights” of the screw auger (a flight is a separate segment of a screw auger representing one 360 degrees section of the screw). The slurry may be introduced at each flight along the entire length of the auger or introduced along only a portion of the flights. In one example, the slurry is introduced to the flights that extend across the top ⅓ of the screw auger. The slurry may be introduced to flights along the middle ⅓ of the screw auger. In an alternate embodiment, the slurry is introduced to the flights along the bottom ⅓ of the auger. Alternatively, the slurry may be introduced at a discrete section along the auger, e.g., within the bottom ⅓, the middle ⅓, or the top ⅓ of the auger.

Similarly, the carrier fluid or wash/rinse water may be introduced at various flights or locations along any of the screw augers. Rinse water may be introduced along only a portion of the screw auger or to every flight of the screw auger. In one aspect, rinse water is introduced to the flights disposed along the top ⅓ of the screw auger. Rinse water may be introduced to flights along the middle ⅓ of the screw auger. In still other embodiments, rinse water may be introduced to flights along the bottom ⅓ of the screw auger. The rinse water may be introduced along a frontside or pushed along a backside of the screw auger.

Depending on the embodiment, each flight may have an associated nozzle that delivers the wash water or slurry to the auger. The movement of the screw causes a hindered settling environment that causes the particles to stratify based on effective settling velocity. Particles that settle faster move to the bed of the falling velocity screw separator, and the auger pulls these particles upwards, where the material is collected. The speed of the auger, the pitch of the bed, the height of the weir, and the flow rates of the slurry affect the separation of the material. In addition, the number and location of slurry or rinse water distribution points along the flights of the auger may affect separation of the material. Importantly, any of the aforementioned parameters may be adjusted to optimize separation. The screw separator may work in a continuous, rather than batch, mode. In one embodiment, one or more of the screw separators is a ribbon screw separator. In one example, the pitch is 9-16 inches.

The system may additionally comprise controlled flow rates, wherein the rate is controlled to optimize the content of the final product. In one embodiment, flow meters are used to monitor or control flow valves and optimize the flow of water along the first screw. In addition, flow meters and flow valves may be placed at various points throughout the system to selectively control flow rates to any one or more of the screw separators.

The separation system includes a comminution apparatus such as a shredder to prepare the mixed waste for efficient separation by size and density. Comminuted waste will have a range of particle sizes. The comminution apparatus can be configured and operated in a manner that retains three-dimensional nature of the infeed and produces minimal fines. These characteristics can be achieved by selecting a knife geometry and rotation speed in combination with other apparatus features.

The comminuted waste may be conveyed to a size separator that fractionates the mixed waste by size to produce two or more sized waste streams (e.g., at least an over fraction and an under fraction). The sizing may be carried out to produce sized waste streams with a particular desired particle size distribution to facilitate density separation and to produce intermediate streams enriched in particular recyclable or renewable materials. The comminuted waste stream can be analyzed to determine size cutoffs in which the fractions of the stream separate different types of materials into different streams while concentrating similar types of waste into somewhat concentrated streams. In addition, the sized waste streams may be optimized for density separation by creating a sized waste stream with a narrow distribution of particles. In one embodiment, the sized waste streams may have a size distribution with a ratio of small particles to large particles of less than about 10 (i.e., the ratio of the upper cut-off to the lower cut-off has a ratio less than about 10) or less than about 8, 6, or 4.

The waste stream or material, which has been sized and separated, may be introduced into system 100 through feeder 110 and eventually to one or more rotating screws. From the feeder 110, the waste stream or material flows into an optional first screw separator 115. The first screw separator 115 can be at an angle with respect to the ground or the horizontal plane. Solids are pressed to the end and discharged, e.g., to a slurry tank 130. The larger material is carried forward along the auger to a slurry tank 130. The extreme lights (plastics, woods, foam etc.) are removed through the first separation, which generally leaves materials heavier than water to continue onward to the slurry tank 130.

The slurry tank 130, which may have an impeller, uses mechanical shearing of solids in a liquid (such as water) to separate particles having different characteristics. At this step, the materials can be broken up and mixed for uniformity or even distribution. In one embodiment, mud, water, or a combination of thereof is added to the slurry tank to dilute the mixture.

From the slurry tank 130, the material is conveyed to an optional distribution box 120. The distribution box 120 slows the flow of material through the system. The slurry may be about 20 to 35 percent (%) solid material. The distribution box 120 can break the flow of material, allowing for the flow of material to be relatively constant.

From the distribution box 120, the material or stream is conveyed to a second screw 140. The second screw separator 140, which may be at an angle with respect to the horizontal plane, may be larger than the first screw separator 115 and may be the largest screw in the system 100. Again, the second screw separator 140 separates materials by density and/or shape. One or more walls of water may be distributed across the second screw 140. A wall of water may comprise non-pressured water that overflows into the screw. The wall of water may be introduced to the second screw in an amount sufficient to cause a 2-fold to 10-fold increase in the slurry volume, thereby diluting the slurry mixture. The wall of water may comprise the majority of the water in the system 100.

The water carries the particles with a settling velocity less than the water current velocity, hereinafter referred to as “lights,” over a weir where they are collected separately from the particles of the material that have a settling velocity greater than the water current velocity. The velocity of the current can be adjusted to maximize the separation of desired constituents, such as precious metals. Furthermore, the rate of the screw can be adjusted to control the period in which the materials reside therein, which further refines the quality of separation.

The light portion or “lights” from the second screw separator 140 flow to the third screw separator 150, where the product is a mids material/aggregate mixture 160 and a water slurry (“tails”) 165. The tails 165 flow to a treatment step and may be discarded from the system 100. The water may be collected and used in the process.

A constant flow of water can be established through multiple sprays of water into the second screw separator 140. The water is distributed across the width of the second screw 140 or may be distributed using a manifold. In some examples, the spray or spray nozzles may distribute water at a rate of between 0.1 gallons per minute and 200 gallons per minute or more. In certain examples, there can be between 1 and 20 nozzles or sprays. A flow of fresh water and/or wash water may be introduced into the second screw separator 140. The flow of and/or pressure of water may be controlled to optimize or obtain desired results. The use of flow meters and controlled water valves may be used to optimize the results.

The heavy portion or “heavies” from the second screw separator 140 are sent to a magnetic separator 170, which may be fed fresh water. The magnetic separator 170 can be used to separate ferromagnetic materials from the waste stream or material. The magnetic separator 170 may be a wet magnetic drum separator such as that used in magnetic media recovery or purification of solids carried in liquid suspension and in iron ore concentration.

The ferromagnetic materials with water may be introduced into a dewatering screw press 180, which may yield ferrous metal and water to be treated. The screw press squeezes the material against a screen or filter and the liquid is collected through the screen for collection and use. The amount of water and the flow of water can be used to adjust the results and separation from the magnetic separator 170. In one example, the water solution, containing some residual unprecipitated metals, can be diverted to system. Again, the speed of the dewatering screw 180 and the angle of the dewatering screw press 180 (with respect to the ground) may be adjusted to optimize the system and method.

The material or drops from the magnetic separator 170 travel to a polishing screw/classifier separator 190, which may be fed fresh water or rinse or some other liquid. The polishing screw separator may be smaller or substantially smaller than the second screw sepatrator 140. In some examples, the diameter of the polishing screw separator 190 may be about one-third the diameter of the second screw separator 140. The polishing screw 190 employs a vessel and a weir to separate the materials into a water/metal slurry portion (“tails”) 200 and a precious metal or metal concentrate portion 210. In operation of the polishing screw separator 190, the slurry to be separated is introduced through the top of the screw separator, and the material distributes across the width of the screw separator. Particles within the slurry having a higher settling velocity than the velocity of the rising current fall through the vessel of screw separator. The liquid flow can be controlled similar to that of the liquid associated with second screw separator 140.

The “tails” fraction 200 (i.e., the fraction of particles with the slowest settling velocity) travel out of the bed, over the weir, and are conveyed to the second screw separator for further processing. The “tails” fraction (such as precious metals, which fall at a slower velocity due to their shape) move to the top surface of the water, which moves down the bed towards the weir. The “heavy” fraction (e.g., copper, zinc, ferrous, and others) as well faster-sinking objects (e.g., spherical pieces and electronic pin connectors) form a metal concentrate 210 that can also be collected and processed. Again, the angle of the screw separator 190 (e.g., with respect to the ground), the speed of the screw separator 190, and/or the system fluid rates can be adjusted to optimize the process.

Metals or precious metal particles found in the waste stream form the “tails” fraction 200 and typically have a flat shape. As such, even though these metals may have relatively high densities, the shape of the particles reduces their settling velocity. The hindered settling conditions within the polishing screw separators also contribute to this reduced settling velocity. As a consequence, these particles 200 have a settling velocity less than that of the rising current of water, resulting in the particles being carried upward in the polishing screw separator.

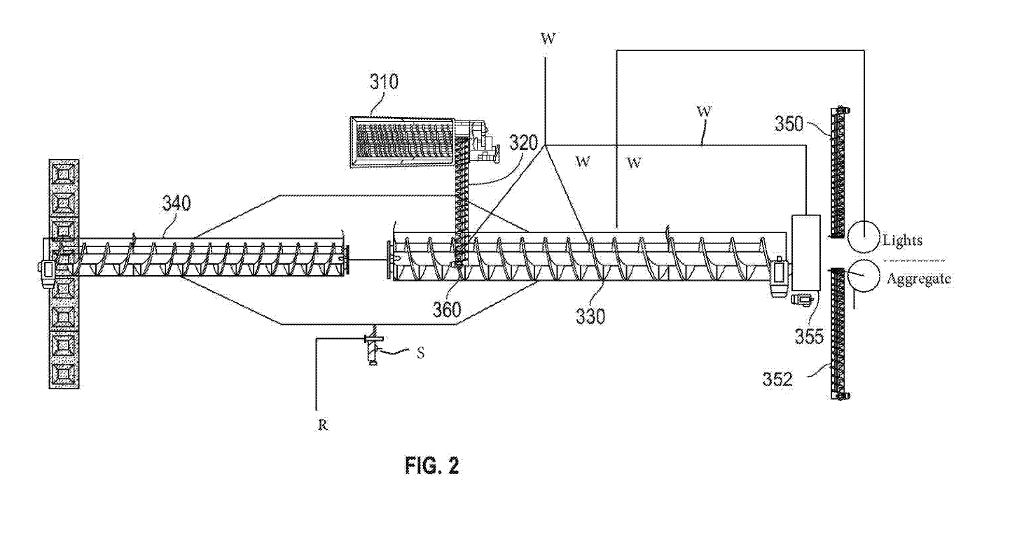

Referring to FIG. 2, a system 300 for recovering metals from a waste stream is described. The system 300 represents an exemplary implementation and, therefore, various components may be omitted depending on implementation and design choice. As can be seen, the system in this specific embodiment has (a) feeder 310, (b) a first screw separator 320, (c) a second screw separator 330, (d) a third screw separator 340, (e) a polishing screw separator 352, (f) an optional dewater screw 350 (g) a wet magnet 355, water W, a sump S, return water R to the sump S, and (h) a distribution box 360. As can be seen, the water is represented by lines W, and the sump S directs return water R to the second and third screw separators 330, 340. This system may operate according to the layout shown in FIG. 1.

Energy and water conservation are another advantage provided by certain embodiments. In these embodiments, the system is maintained so that water discharged from components is subsequently used as wash material in another component. In this way, the water and energy requirements for the system can be significantly reduced. Although the system requires the addition of water, the amount is significantly less than would otherwise be the case.

The methods and systems can be automated to allow higher efficiencies. The systems and methods may employ proportional-integral-derivative controllers. By way of non-limiting example, these proportional-integral-derivative controllers may allow for control and monitoring of the speeds of the components, the angles of the screw separators (e.g., with respect to the ground), the flow of the slurry, or the flow of water. Such flexible adjustment of the multiple screws may result in higher efficiencies. By employing automatic controllers and monitors, the process may allow reduced downtime and greater flexibility.

It will be appreciated that the embodiments described herein are susceptible to modification, variation and change without departing from the spirit of the invention. Thus, the description above represents only selected embodiments and is, therefore, not to be considered limiting of scope, for the inventions may admit to other equally effective embodiments and applications.

What is claimed is:

1. A system for recovering metals from a waste stream comprising:
a feeder configured to introduce the waste stream into the system, wherein the flow rate of the waste stream is adjustable;
a first screw separator configured to receive the waste stream from the feeder, wherein the first screw separator further comprises a first walled bed that receives settled particles from the waste stream;
a slurry tank configured to receive the particles that settle within the first walled bed; and
a carrier fluid configured to disperse the particles uniformly within the slurry tank;
wherein the carrier fluid is introduced into the slurry tank;
a second screw separator configured to receive carrier fluid and particles from the slurry tank, wherein carrier fluid flows at a constant velocity;
a plurality of walled beds configured to receive particles from the waste stream that settle as the waste stream passes along the screw separators, wherein each of the walled beds has an adjustable pitch;
a weir, wherein the height of the weir is adjustable; and
a controlled liquid flow mechanism configured to dispense water to the first screw separator and the second screw separator.

2. The system of claim 1, further comprising
a polishing screw separator, wherein the carrier fluid flows at a second constant velocity;
a second weir; wherein the non-ferromagnetic materials further comprise a slurry portion and a metal concentrate portion; wherein the slurry portion has a settling velocity that is less than the second velocity of the carrier fluid; the metal concentrate portion has a settling velocity that is greater than the second velocity of the carrier fluid; the slurry portion flows over the weir to be conveyed back to the second screw separator for further processing; and the metal concentrate portion is collected separately from the water/metal slurry portion.

3. The system of claim 1, further comprising a magnetic separator configured to separate the particles into ferromagnetic materials and non-ferromagnetic materials.

4. The system of claim 2, further comprising a distribution box disposed between the slurry tank and the second screw separator, wherein the distribution box is configured to create a constant flow of carrier fluid and particles through the system.

5. The system of claim 4, wherein a light portion of the particles with a first settling velocity that is less than the velocity of the carrier fluid; a heavy portion of the particles with a second settling velocity that is greater than the velocity of the carrier fluid; and the light portion of particles flow over the weir to be collected separately from the heavy portion of particles.

6. The system of claim 5, further comprising:
a third screw separator configured to receive the light portion of particles, wherein the third screw separator is further configured to divide the light portion of particles into an aggregate mixture and a carrier fluid slurry portion; wherein the carrier fluid slurry portion comprises disposable tails material.

7. The system of claim 6, wherein the carrier fluid is water.

8. The system of claim 5, further comprising a magnetic separator configured to separate the heavy portion of particles into ferromagnetic materials and non-ferromagnetic materials.

9. The system of claim 8, further comprising a dewatering screw press and a filter that are configured to separate the ferromagnetic materials from the carrier fluid.

10. The system of claim 5, wherein the velocity of the carrier fluid is adjustable.

11. The system of claim 1, further comprising:
an input mixed waste; and
a comminution apparatus configured to receive and process the input mixed waste into the waste stream.

12. The system of claim 11, further comprising a size separator configured to fractionate an output from the comminution apparatus into two or more waste streams according to particle size.

13. The system of claim 1, wherein at least one of the plurality of screw separators is a ribbon screw separator.

14. The system of claim 1, wherein the waste stream comprises incinerator ash, automobile shredder residue, whitegood shredder residue, waste electrical and electronic equipment, building component residue, or retrieved landfill material.

15. The system of claim 1, wherein the waste stream comprises hair wires, electronic pin connectors, or metals with flat, flake-like shapes.

16. A method for processing mixed solid waste to recover metals from a waste stream comprising:
passing a waste stream through the system of claim 1; and
separating particles within the waste stream according to the particles' settling velocities and densities.

17. The method of claim 16, further comprising:
passing the waste stream from the feeder onto a first screw separator;
allowing particles from the waste stream to settle into a first walled bed of the first screw separator;
discharging settled particles from the first walled bed into a slurry tank; and
adding a carrier fluid to the slurry tank, wherein the carrier fluid resuspends the settled particles to permit later the separation of the particles according to a settling velocity of the particles.

18. The method of claim 17, further comprising:
passing the carrier fluid and particles to a second screw separator, wherein carrier fluid flows at a constant velocity;
allowing a light portion of the particles to pass over a first weir, wherein the light portion of particles has a first settling velocity that is less than the velocity of the carrier fluid; and
collecting a heavy portion of the particles in a first vessel, wherein the heavy portion of the particles has a second settling velocity that is greater than the velocity of the carrier fluid.

19. The method of claim 18, further comprising:
passing the light portion of the particles to a third screw separator, wherein the third screw separator divides the light portion of particles into an aggregate mixture and a carrier fluid slurry portion; wherein
the carrier fluid slurry portion comprises disposable tails material.

20. The method of claim 19, further comprising separating the carrier fluid from the tails and recycling the carrier fluid back into the system.

21. The method of claim 18, further comprising separating the heavy portion of the particles into ferromagnetic material and non-ferromagnetic materials via a magnetic separator.

22. The method of claim 21, further comprising separating the ferromagnetic materials from the carrier fluid with a dewatering screw press and a filter.

23. The method of claim 21, further comprising:
passing the non-ferromagnetic materials to a polishing screw separator, wherein the carrier fluid flows at a second constant velocity;
separating the non-ferromagnetic materials into a water/metal slurry portion and a metal concentrate portion;
allowing a water/metal slurry portion of the non-ferromagnetic materials to pass over a second weir, wherein the water/metal slurry portion has a settling velocity that is less than the second velocity of the carrier fluid;
collecting a metal concentrate portion of the non-ferromagnetic materials into a second vessel, wherein the metal concentrate portion has a settling velocity that is greater than the second velocity of the carrier fluid; and
conveying the water/metal slurry portion back to the second screw separator for further processing.

24. The method of claim 17, further comprising:
optimizing separation of the waste stream by adjusting any one or more of the following: the speed of the auger, the pitch of the bed, the height of the weir, the flow rate of the liquid along the second separator, and the flow rate of the waste stream.

25. A system for recovering metals from a waste stream comprising:
a feeder configured to introduce the waste stream into the system, wherein the flow rate of the waste stream is adjustable;
a slurry tank configured to receive the particles that settle within the first walled bed;
a carrier fluid configured to disperse the particles uniformly within the slurry tank;
wherein the carrier fluid is introduced into the slurry tank;
a screw separator configured to receive carrier fluid and particles from the slurry tank, wherein carrier fluid flows at a constant velocity;
a plurality of walled beds configured to receive particles from the waste stream that settle as the waste stream passes along the screw separators, wherein each of the walled beds has an adjustable pitch;
a weir, wherein the height of the weir is adjustable; and
a controlled liquid flow configured to dispense water to the second screw separator.
